(19) United States
(12) Patent Application Publication
(10) Pub. No.: US 2017/0135899 A1
(43) Pub. Date: May 18, 2017

(54) System, apparatus, and method to attach and secure decorative accessory, cover, disguise, and or enhancement to acupressure device and other wearable items

(71) Applicant: Kellyann Parrillo Milkowski, Bridgeport, CT (US)

(72) Inventor: Kellyann Parrillo Milkowski, Bridgeport, CT (US)

(21) Appl. No.: 15/261,910

(22) Filed: Sep. 10, 2016

Related U.S. Application Data
(60) Provisional application No. 62/216,659, filed on Sep. 10, 2015.

(51) Int. Cl. A61H 39/04; A44C 5/20

(52) U.S. Cl. CPC A61H 39/04; A44C 5/20; A44D 2203/00

(57) ABSTRACT

The main embodiment is a system, apparatus, and method for attaching a decorative accessory, cover, disguise, and or enhancement to an acupressure device ordinarily worn on the wrist or other wearable item. The system, apparatus, and method comprising a clip with magnetic properties, top and bottom sides also referred herein as first end A and second end B, which holds onto an acupressure device or other wearable item, the bottom side also referred to as second end B inserting between the acupressure device and the body of the user and the top side also referred to as first end A holding flush to the top of the acupressure device or other wearable item, remaining exposed, configured to engage a magnetic component and a decorative accessory, cover, disguise, and or enhancement in which the magnetic component is incorporated.

The decorative accessory, cover, disguise, and or enhancement is a decorative overlay comprising of one or more magnetic components that correspond to the clip(s) placed onto the acupressure device or other wearable item to secure the decorative accessory onto the acupressure device or other wearable item, covering the acupressure device or other wearable item in part or in whole, preventing the decorative accessory from displacing from covering the acupressure device or other wearable item. Thereby providing a decorative overlay to a functional wearable item, allowing for discretion for cause to wear the acupressure device or other wearable item and personalization of the wearable item.

This application claims priority benefit to Provisional Application 62/216,659, filed Sep. 10, 2015.

### DESCRIPTION

Field

The present invention relates to systems and methods for securing decorative accessory, cover, disguise, and or enhancement to wearable items. In particular, but not by way of limitation, the present invention relates to systems and methods for securing accessories to apparatuses worn at acupressure points.

Background

Many individuals suffer from nausea due to motion sickness, pregnancy, medical treatment and myriad other causes. Many companies manufacture several types of wearable items secured at the wrist, an area of the body considered to be a ‘pressure point’, designed to stimulate without interference. It is believed that acupressure, which is the activating of different pressure points on the body, will control, lessen, eliminate or otherwise positively affect maladies, such as nausea, experienced by a person.

Many of these items are purely functional in design and as a result, displeasing to look at or otherwise conspicuous. It is possible that the person utilizing the positive effects of such a device is doing so for personal reasons and wishes to keep confidential the intimate underlying condition such as in the case of pregnancy or illness, or would wish to simply wear an item that is aesthetically pleasing.

The wearable acupressure devices are manufactured out of myriad materials dependent on each individual brand and manufacturer. The acupressure devices consist of a acupressure device with a knob or rounded button that is placed on the inside of the forearm to rest on the P6 pressure point, also referred to as HP6 or PC6, which is located approximately two inches above wrist crease on the forearm, at the pericardium meridian.

BioBands™, whose contact information is P.O. Box 393, Roslyn, N.Y. 11576, 1800-BIO-BAND (1-800-246-2263) within the U.S., email info@biobands.com, is one of many manufacturers and suppliers of one design of acupressure device. The design of the wearable acupressure device manufactured and sold under the brand BioBands is not critical to the correct use, application or enjoyment of the system apparatus and method of the decorative accessory, cover, disguise and or enhancement as described in this application. The design of the acupressure device manufactured and sold under the brand BioBands is used here for illustrative purposes only and is not in any way part of any claim made. The method, system and apparatus of the decorative cover as described in this application can be correctly used, applied or enjoyed with any wearable acupressure device designed to rest on the P6 pressure point or other wearable item.

Creating an decorative accessory, cover, disguise, and or enhancement to overlay an acupressure device or other wearable item was a challenge because even light activity increases the likelihood of a decorative accessory, cover, disguise, and or enhancement displacing off of the acupressure device or other wearable item onto a different part of the body. More over, the acupressure devices and other wearable items are usually used to relieve nausea caused by several different factors making durability, security during activity, and aesthetics all equally important and challenging. Also challenging is the differences in the width and thickness of the acupressure devices or other wearable items between the several different manufacturers and brands. The difference in size makes it difficult to design an apparatus, system, and method with the capacity and capability of fitting any acupressure device or other wearable item regardless of manufacturer and/or brand. In addition, for many brands, the acupressure device or other wearable item varies in size for children and adult models, making for further challenge in creating a method, apparatus, and system that works for both children and adults.

### SUMMARY OF THE INVENTION

Depictions of the present invention illustrated in the drawings are summarized below. These and other embodiments are more extensively described in the Detailed Description section. It is important to note that there is no intention to limit the invention to the manifestations, formations, configurations, or arrangements described in this Summary of the Invention or in the Detailed Description. One skilled in the art can recognize that there are innumerable variations, adjustments, adaptations, and comparable and alternative constructions that lie within the essence and scope of the invention as expressed in the claims.

Depictions of the present invention illustrated in the drawings show a system and apparatus that secures a decorative accessory, cover, disguise, and/or enhancement to a wearable acupressure device or other wearable item. The apparatus, system, and method comprises a thin clip with a first end and a second end that secures onto the acupressure device or other wearable item by slipping onto the acupressure device or other wearable item so that one end, referred to herein as first end A also referred to as top side, sits exposed on the visible surface of the acupressure device or other wearable item when in use, and the other end, referred to herein as second end B also referred to as bottom side, is held between the body of the user and the acupressure device or other wearable item. The clip is applied so that the first end A also referred to as top side and the second end B also referred to as bottom side hold against the acupressure device or other wearable item from multiple surfaces. The clip comprises materials that have magnetic properties either in whole or in part. The apparatus, system, and method also comprises a decorative accessory, cover, disguise, and/or enhancement that fits around the body part the acupressure device or other wearable item is designed to be situated, overlaying the acupressure device or other wearable item, in part or in whole, securing by way of one or more magnetic components to the exposed first end A also referred to as top side of one or more clips that is comprised of magnetic materials. The decorative accessory, cover, disguise, and/or enhancement is comprised of one or more strands. The individual strand or strands can be comprised of any material or materials alone or in any combination. The individual strand or strands are strung with one or more decorative elements that comprise any material, including but not limited to semi-precious stones, stones, acrylic, plastic, glass, metal, wood, ceramic, etc. The decorative elements are variable in form and design, and can be of any shape any size and any color. The decorative accessory, cover, disguise, and/or enhancement also contains one or more magnetic components strung on the one or more strands. The magnetic component is comprised of a magnet and housing in which the magnet is contained. The housing portion of the magnetic component is comprised of any material, including but not limited to metal, ceramic, acrylic, plastic, glass, wood, stones, semi-precious stones, etc. The shape and size and design of the magnetic component are variable and can take any form or color. The decorative accessory, cover, disguise and/or enhancement maintains its placement overlaying the acupressure device or other wearable item by way of the magnetic component engaging the exposed surface section of the clip first end A also referred to as top side that is held to the acupressure device or other wearable item.

### BRIEF DESCRIPTION OF THE DRAWINGS

FIG. 1 is a side view of the clip, showing the first end A also referred to as top side and the second end B also referred to as the bottom side;

FIG. 2 is a rear view of the clip, showing the area of the clip outer end C that may or may not remain exposed in part or in whole after correct application of the decorative accessory, cover, disguise, and/or enhancement component;

FIG. 3 is a front view of the clip, showing the area of the clip that will abut the acupressure device or other wearable item during correct application of the decorative accessory, cover, disguise, and/or enhancement component;

FIG. 4 is a top view of the clip, showing the area of the first end A also referred to as top side which remains exposed on the surface portion of the acupressure device or other wearable item. It is to the first end A also referred to as top side that the magnetic component is engaged;

FIG. 5 is a top view of an alternative manifestation of the clip, showing the area of the first end A also referred to as top side of the clip that remains on the surface portion of the acupressure device or other wearable item. It is to the first end A also referred to as top side that the magnetic component is engaged;

FIG. 6 is a rear view of an alternative manifestation of the clip, showing the area of the clip that may or may not remain exposed in whole or in part after correct application of the decorative accessory, cover, disguise, and/or enhancement;

FIG. 7 is an angled top view of an alternative manifestation of the clip, showing the first end A also referred to as top side and the second end B also referred to as bottom side;

FIG. 8 is a side view of an alternative manifestation of the clip, showing the first end A also referred to as top side and the second end B also referred to as bottom side;

FIG. 9 is an angled top view of an alternative manifestation of the clip, showing the first end A also referred to as top side and the second end B also referred to as bottom side;

FIG. 10 is a top view of an alternative manifestation of the clip, showing the area of the second end B also referred to as bottom side of the clip that holds between the body of the user and the acupressure device or other wearable item;

FIG. 11 is an angled top view of an alternative manifestation of the clip, showing the first end A also referred to as top side and the second end B also referred to as bottom side;

FIG. 12 is a rear view of an alternative manifestation of the clip, showing the area of the clip outer side C which may or may not remain exposed in whole or in part after correct application of the decorative accessory, cover, disguise, and/or enhancement component;

FIG. 13 is a side view of an alternative manifestation of the clip, showing the first end A also referred to as top side and the second end B also referred to as bottom side;

FIG. 14 is a top view of an alternative manifestation of the clip, showing the area of the first end A also referred to as top side of the clip that remains on the surface portion of the acupressure device or other wearable item. It is to the first end A also referred to as top side that the magnetic component is engaged;

FIG. 15 is a top view of an alternative manifestation of the clip, showing the area of the second end B also referred to as bottom side of the clip that holds between the body of the user and the acupressure device or other wearable item;

FIG. 16 is a view of a visual representation of a possible decorative accessory, cover, disguise, and/or enhancement component affixed to the acupressure device or other wearable item located at the pericardium meridian. The visual representation of the decorative accessory, cover, disguise, and/or enhancement component as depicted herein is solely for purposes of illustration and is not intended to limit the scope of the invention in any way;

FIG. 17 is a cross view of the visual representation of a possible decorative accessory, cover, disguise, and/or enhancement component affixed to the acupressure device or other wearable item. The visual representation of the decorative accessory, cover, disguise, and/or enhancement component as depicted herein is solely for purposes of illustration and is not intended to limit the scope of the invention in any way;

FIG. 18 is a close up view of the visual representation of a possible variation in size, shape, and orientation manifestation of the magnetic component that will engage with the clip. The visual representation of the magnetic component as depicted herein is solely for purposes of illustration and is not intended to limit the scope of the invention in any way;

and

FIG. 19 is a close up view of the visual representation of a possible variation in size, shape, and orientation manifestation of the magnetic component that will engage with the clip. The visual representation of the magnetic component as depicted herein is solely for purposes of illustration and is not intended to limit the scope of the invention in any way.

### DETAILED DESCRIPTION

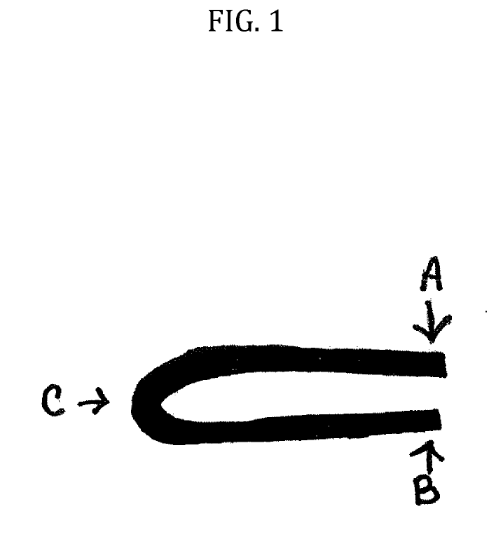

Referring to FIGS. 1 through 4, a variation of the manifestation of a symmetrical clip having similarly shaped ends. The first end A also referred to as top side and second end B also referred to as bottom end are interchangeable during the correct use of the present invention. Distinction between the first end A also referred to as top side and second end B also referred to as bottom side is made solely for the purposes of illustration and is not intended to limit the use of the present invention.

The first end A also referred to as top side, the second end B also referred to as bottom side, and the outer end C are equal in shape and size throughout the clip in this variation of manifestation. The clip is of equal width throughout the length from first end A also referred to as top side, through outer end C, to second end B also referred to as bottom side. The clip is comprised of a singular length of material consisting magnetic properties, which is bent at the segment referred to as outer end C.

The first end A also referred to as top side will remain exposed when properly applied to an acupressure device or other wearable item prior to correct application of the decorative accessory, cover, disguise, and/or enhancement, laying flush on the outer surface. The second end B also referred to as bottom side is inserted between an acupressure device or other wearable item and a user's body. The outer end C may or may not remain exposed in whole or in part after the application of the decorative accessory, cover, disguise, and /or enhancement. The efficacy of the present invention is not affected whether or not outer end C remains exposed or is concealed in whole or in part by the decorative accessory, cover, disguise, and/or enhancement.

Referring to FIG. 1, a cross section view of the clip presenting first end A also referred to as top side, second end B also referred to as bottom side, and outer end C from the side of the clip, showing the inside area of the clip that an acupressure device or other wearable item would fit flush against all ends when properly affixed.

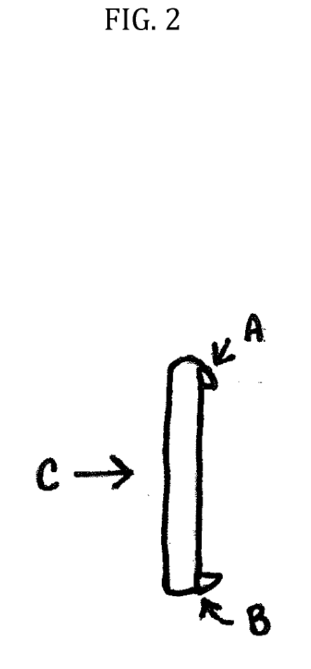

Referring to FIG. 2, a different view of the clip focusing on the outer end C as it will appear when affixed to an acupressure device or other wearable item.

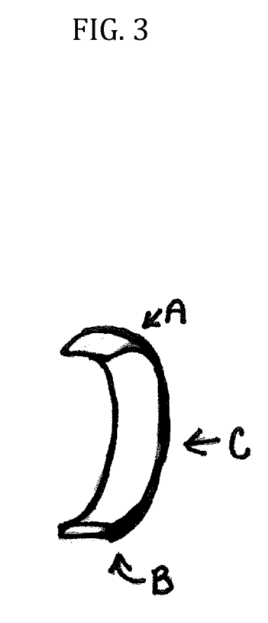

Referring to FIG. 3, a different view of the clip, focusing on the inner surface of the clip which will be flush against an acupressure device or other wearable item on all sides when properly affixed.

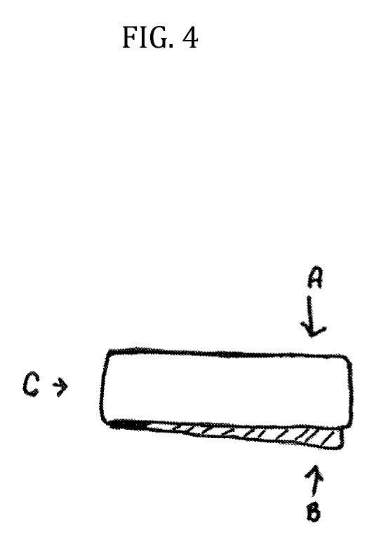

Referring to FIG. 4, a different view of the clip, the exposed first end A also referred to as top side as it will lay flush to the outer surface of an acupressure device or other wearable item. The second end B also referred to as bottom side is viewed in part to illustrate the symmetry of the clip.

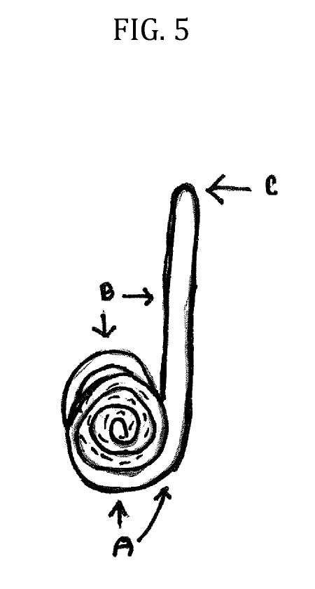

Referring to FIGS. 5 through 10, a variation of the manifestation of a symmetrical clip having similarly shaped ends. The first end A also referred to as top side and the second end B also referred to as bottom side are interchangeable during the correct use of the present invention. Distinction between the first end A also referred to as top side and second end B also referred to as bottom side is made solely for the purposes of illustration and is not intended to limit the use of the present invention in any way.

In the present manifestation of the invention, the first end A also referred to as top side and the second end B also referred to as bottom side are circular in shape, a result of a spiraling of thin gauged wire consisting magnetic properties. The outer end C is a singular connection of the thin-gauged wire consisting magnetic properties. The first end A also referred to as top side the second end B also referred to as bottom side, and the outer end C are comprised of one singular length of thin gauged wire consisting magnetic properties which is bent at the segment outer end C.

The first end A also referred to as top side will remain exposed when properly applied to an acupressure device or other wearable item prior to correct application of the decorative accessory, cover, disguise, and/or enhancement, laying flush on the outer surface of the acupressure device or other wearable item. The second end B also referred to as bottom side is inserted between the acupressure device or other wearable item and user's body. The outer end C may or may not remain exposed in whole or in part after the application of the decorative accessory, cover, disguise, and/or enhancement. The efficacy of the present invention is not affected whether or not outer end C remains exposed or is concealed in whole or in part by the decorative accessory, cover, disguise, and/or enhancement.

Referring to FIG. 5, a top view of the clip, the exposed first end A also referred to as top side flush on the outer surface of an acupressure device or other wearable item. The second end B also referred to as bottom side is viewed in part to illustrate symmetry of the clip.

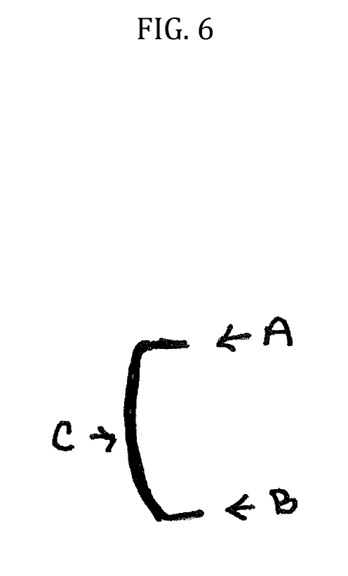

Referring to FIG. 6, a different view of the clip focusing on the outer end C as it will appear when affixed to an acupressure device or other wearable item.

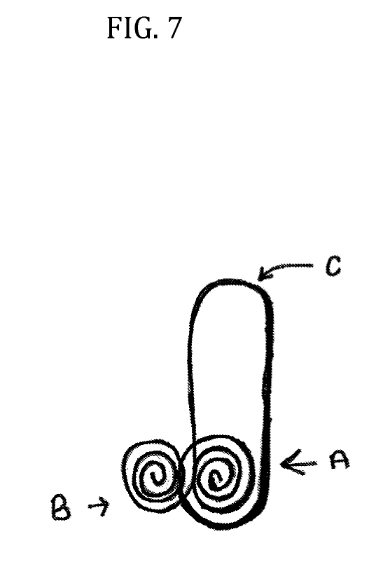

Referring to FIG. 7, a similar view to FIG. 5, slightly angled to illustrated the symmetry of the first end A also referred to as top side and second end B also referred to as bottom side.

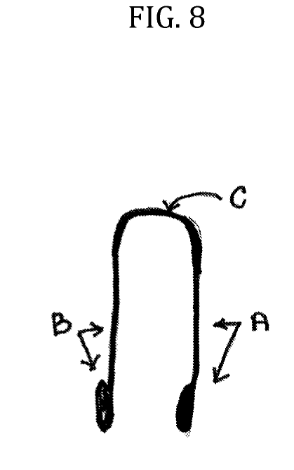

Referring to FIG. 8, a cross section view of the clip presenting first end A also referred to as top side, second end B also referred to as bottom side, and outer end C from the side of the clip, showing the inside area of the clip that an acupressure device or other wearable item would abut against all ends when properly affixed.

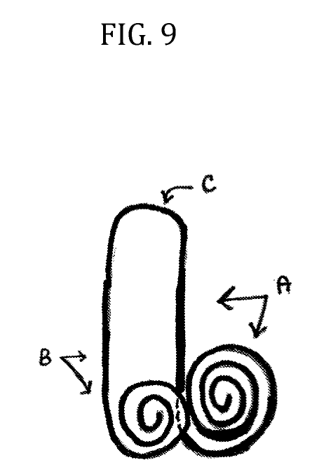

Referring to FIG. 9, a reverse view of FIG. 7, slightly angled to illustrated the symmetry of the first end A also referred to as top side and second end B also referred to as bottom side.

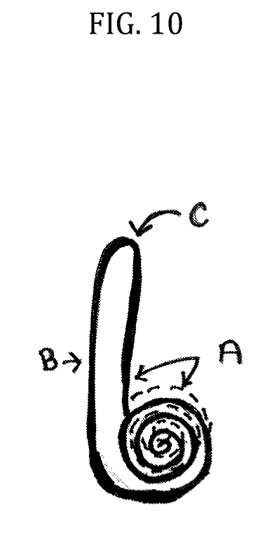

Referring to FIG. 10, a reverse view of FIG. 5, a top view of the clip, the second end B also referred to as bottom side exposed in this drawing of the clip to illustrate that the clip is completely reversible in its placement on an acupressure device or other wearable item and that the first end A also referred to as top side and second end B also referred to as bottom side are interchangeable in the efficacy of the present invention.

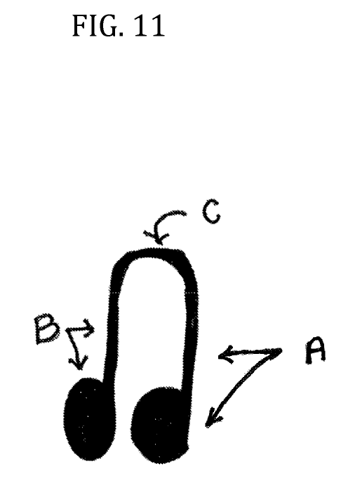

Referring to FIGS. 11 through 15, a variation of the manifestation of a symmetrical clip having similarly shaped ends. The first end A also referred to as top side and the second end B also referred to as bottom side are interchangeable during the correct use of the present invention. Distinction between the first end A also referred to as top side and second end B also referred to as bottom side is made solely for the purposes of illustration and is not intended to limit the use of the present invention in any way.

The first end A also referred to as top side and the second end B also referred to as bottom side are circular in shape comprising materials consisting of magnetic properties. The outer end C is a singular connection of the thin-gauged material. The first end A also referred to as top side the second end B also referred to as bottom side, and the outer end C may be comprised of one singular length of material or may be attached by secondary methods including but not limited to adhesives and/or welding or other methods.

The first end A also referred to as top side will remain exposed when properly applied to an acupressure device or other wearable item prior to correct application of the decorative accessory, cover, disguise, and or enhancement, laying flush on the outer surface of the acupressure device or other wearable item. The second end B is inserted between an acupressure device or other wearable item and user's body. The outer end C may or may not remain exposed in whole or in part after the application of the decorative accessory, cover, disguise, and/or enhancement. The efficacy of the present invention is not affected whether or not outer end C remains exposed or is concealed in whole or in part by the decorative accessory, cover, disguise, and/or enhancement.

Referring to FIG. 11, a top view of the clip slightly angled to illustrate the symmetry of the first end A also referred to as top side and second end B also referred to as bottom side.

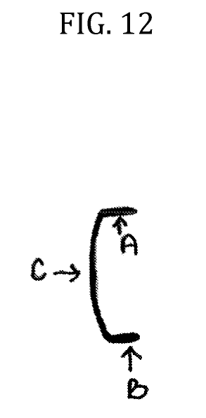

Referring to FIG. 12, a different view of the clip focusing on the outer end C as it will appear when affixed to an acupressure device or other wearable item.

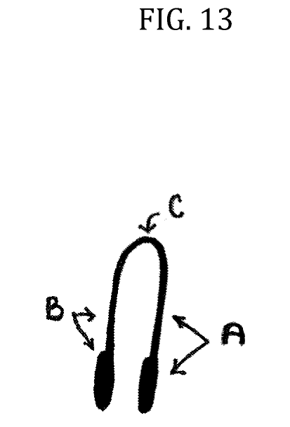

Referring to FIG. 13, a cross section view of the clip presenting first end A also referred to as top side, second end B also referred to as bottom side, and outer end C from the side of the clip, showing the inside area of the clip that an acupressure device or other wearable item would abut against all ends when properly affixed.

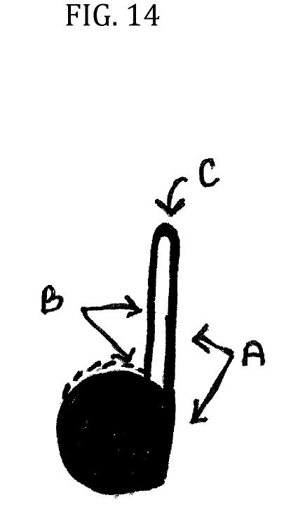

Referring to FIG. 14, a top view of the clip, the exposed first end A also referred to as top side flush to the outer surface of an acupressure device or other wearable item. The second end B also referred to as bottom side is viewed in part to illustrate symmetry of the clip.

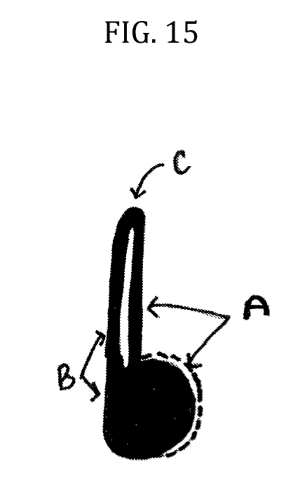

Referring to FIG. 15, a reverse view of FIG. 14., a top view of the clip, the second end B also referred to as bottom side exposed in this drawing of the clip to illustrate that the clip is completely reversible in its placement on an acupressure device or other wearable item and that the first end A also referred to as top side and the second end B also referred to as bottom side are interchangeable in the efficacy of the present invention.

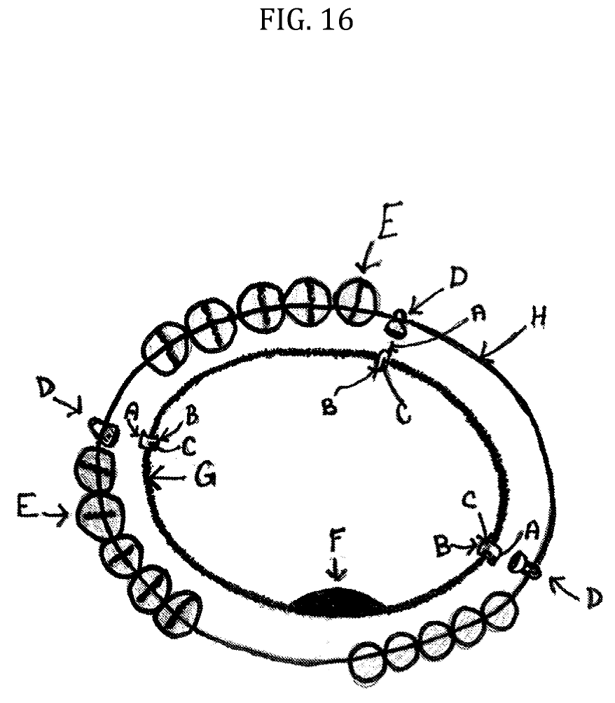

Referring to FIG. 16 a cross section view of an acupressure device, the clip, and the decorative accessory, cover, disguise, and/or enhancement containing the magnetic component, as the combination of acupressure device and decorative accessory, cover, disguise, and/or enhancement would appear properly assembled and affixed according to the present invention. The number of magnetic components contained in the decorative accessory, cover, disguise, and/or enhancement is variable. The present illustration is that of a decorative accessory, cover, disguise, and/or enhancement containing three magnetic components and three clips affixed to the acupressure device. The clip can be placed on either edge of an acupressure device or other wearable item without compromising the efficacy of the present invention. Each clip is designated first end A also referred to as top side placed on the surface of the acupressure device that is exposed to the decorative accessory, cover, disguise, and/or enhancement, second end B also referred to as bottom side placed on the side of the acupressure device that is against the user's body, and outer end C that is viewable in the drawing for illustrative purposes only as the clip can be successfully placed on either edge of the acupressure device maintaining efficacy of the present invention. The magnetic component D is a part of the decorative accessory, cover, disguise, and/or enhancement. The magnetic component D is placed between beads E on the strand H that comprises the decorative accessory, cover, disguise, and/or enhancement. The magnetic component D can be any variation of quantity, material, shape, size, color, and/or form. The beads E can be any variation of quantity, material, shape, size, color, and/or form. The present drawing is of half round magnetic component D and round beads E for illustrative purposes only and is not meant to limit the present invention in any way. FIG. 16 shows a limited quantity of beads for ease of illustration only, and is not meant to limit the present invention in any way. The magnetic component D is strung on strand H in between beads E. The decorative accessory is secured to the acupressure device or other wearable item G by magnetic component D engaged to the clip first end A also referred to as top side. The placement of the clips on the acupressure device or other wearable item G in relation to the acupressure knob F, which sits at the inside of the forearm to rest on the P6 pressure point, also referred to as HP6 or PC6, which is located approximately two inches above wrist crease on the pericardium meridian, in terms of spatial configuration is variable according to user preference. The clip first end A also referred to as top side remains accessible to the magnetic component D for engagement. The position of the clips in relation to acupressure knob F as shown in the drawing is for illustrative purposes only and is not meant to limit the present invention in anyway. The distance between magnetic components D on the strand H is variable and may or may not be constant between all magnetic components. The distance between magnetic components D on the strand H may or may not be determined by the variable materials, quantity, size, shape, and/or form of the beads E used to assemble the decorative accessory, cover, disguise, and/or enhancement. The distance between magnetic components D on the strand H may or may not be determined by the variable materials, quantity, size, shape, and/or form of the magnetic components D used to assemble the decorative accessory, cover, disguise, and /or enhancement.

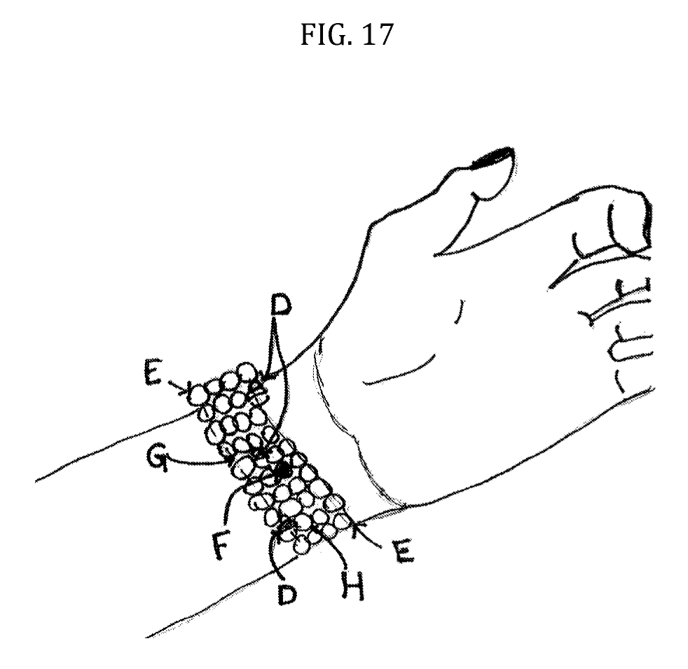

Referring to FIG. 17 a view of a variation of the manifestation of the decorative accessory, cover, disguise, and/or enhancement comprising of beads E and magnetic components D on strand H as the decorative accessory, cover, disguise, and/or enhancement is properly affixed by engagement of magnetic component D to the clip first end A also referred to as top side which is understood to be affixed but not visible in this drawing as it is meant to be representative but not limiting of the ability of the decorative accessory, cover, disguise, and/or enhancement to cover, enhance, and/or disguise an acupressure device or other wearable item G as it sits with the knob F placed on the inside of the forearm to rest on the P6 pressure point, also referred to as HP6 or PC6, which is located approximately two inches above wrist crease on the pericardium meridian.

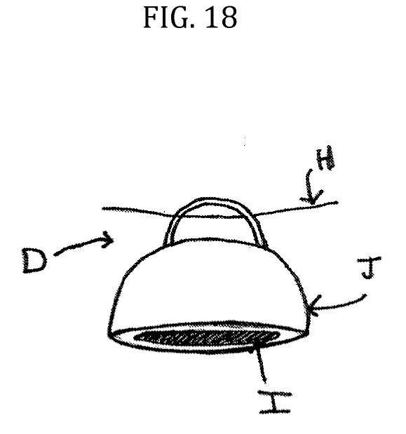

Referring to FIG. 18 a close-up view of a variation of the manifestation of the magnetic component D strung on strand H. The decorative housing J portion of the magnetic component D is variable in color, material, size, shape, and/or form. The magnet I portion of the magnetic component D is variable in color, material, size, shape, and/or form. The magnetic component D is variable in color, material, size, shape, and/or form. FIG. 18 shows a variation of the manifestation of magnetic component D comprising of the decorative housing J in which the magnet I is contained. FIG. 18 shows a variation of the manifestation of how magnetic component D is strung on strand H. The current drawing of a variation of the manifestation of the magnetic component D, comprising the decorative housing J containing the magnet I, strung on strand H is for illustrative purposes only and is not intended to limit the present invention in any way.

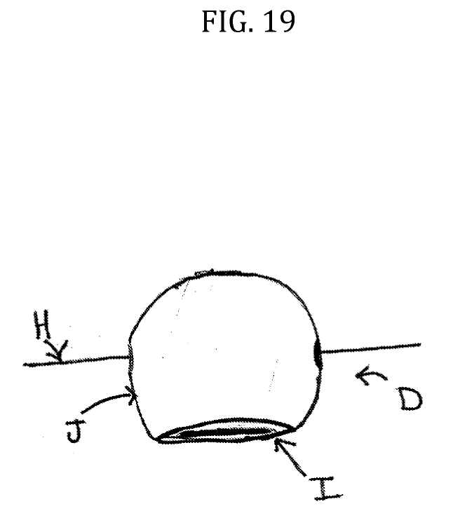

Referring to FIG. 19 a close-up view of a variation of the manifestation of the magnetic component D strung on strand H. The decorative housing J portion of the magnetic component D is variable in color, material, size, shape, and/or form. The magnet I portion of the magnetic component D is variable in color, material, size, shape, and/or form. The magnetic component D is variable in color, material, size, shape, and/or form. FIG. 19 shows a variation of the manifestation of magnetic component D comprising of the decorative housing J in which the magnet I is contained. FIG. 19 shows a variation of the manifestation of how magnetic component D is strung on strand H. The current drawing of a variation of the manifestation of the magnetic component D, comprising the decorative housing J containing the magnet I, strung on strand H is for illustrative purposes only and is not intended to limit the present invention in any way.

### CONCLUSION

In conclusion, depictions of the present invention include, in addition to other things, a system apparatus and method for securing decorative accessory, cover, disguise, and/or enhancement to acupressure devices and other wearable items. Those skilled in the art can easily identify that a multitude of adaptations variations modifications alterations and substitutions may be applied in the invention, its use and its configuration to accomplish substantially similar results as those achieved by the embodiments described herein. Therefore, there is no intention to limit the scope of the invention to the disclosed representative forms. Many adaptations, adjustments, modifications and alternative constructions fall within the scope and essence of the presently disclosed invention as demonstrated in the claims.

What is claimed is:

1. An apparatus to secure, attach, and/or tie decorative accessories, covers, disguises, and/or enhancements to a wearable acupressure band, comprising three elements:
(A) an adjustable clip having a first end A also referred to as top side and a second end B also referred to as bottom side;
(B) a decorative linking element having a decorative housing and magnetic component;
(C) a decorative cover, accessory, enhancement to disguise the wearable acupressure band.

2. An adjustable clip as defined in claim 1, wherein said adjustable clip having no specific shape, length, thickness, density and/or tensile strength comprises three sections:
(A) first end A that sits flush to the top of the acupressure band remaining exposed;
(B) second end B that can vary in size and shape, that sits underneath the acupressure band between the band and the user;
(C) middle section C which bridges first end A and second end B.

3. An adjustable clip as defined in claim 2, wherein said adjustable clip can comprise:
(A) a singular continuous piece of material; or
(B) a primary length of material composing second end B and middle section C with a secondary piece of material composing first end A adhered together by any means including but not limited to glue, welding, etc.

4. An adjustable clip as defined in claim 2, wherein said adjustable clip second end B and middle section C can comprise any material.

5. An adjustable clip as defined in claim 2, wherein said adjustable clip first end A is comprised of a material consisting of magnetic properties, whether itself magnetized or able to attract a magnet or magnetized material.

6. An adjustable clip as defined in claim 2, wherein said adjustable clip comprises a singular continuous piece of material with magnetic properties.

7. An adjustable clip as defined in claim 2, wherein said adjustable clip comprises a primary length of material composing second end B and middle section C consisting of any material adhered to first end A consisting of material with magnetic properties.

8. A decorative linking element as defined in claim 1, wherein said decorative linking element having no specific shape, size, density, tensile strength, material, and/or color comprises two sections:
(A) a decorative housing comprising any material in any size, shape, color, density, and/or tensile strength;
(B) a magnetic component comprising any material with magnetic properties in any size, shape, color, density, and/or tensile strength.

9. A decorative housing as defined in claim 8, wherein said decorative housing comprising any material, in any shape, size, density, tensile strength, and/or color holds the magnetic component concealing it from plain sight.

10. A magnetic component as defined in claim 8, wherein said magnetic component comprising any material with magnetic properties, whether natural magnet or magnetized alloy, in any size, shape, color, density, and/or tensile strength adheres to the decorative housing by any means including but not limited to glue, solder, fuse, interlocking pieces, encasement.

11. A magnetic component as defined in claim 8, wherein said magnetic component connects the entire decorative linking element to the clip at first end A.

12. A decorative cover, enhancement, disguise as defined in claim 1, wherein said decorative cover, enhancement, disguise overlays the wearable acupressure band hiding the wearable acupressure band.

13. A decorative linking element as defined in claim 8, wherein design of the said decorative linking element is variant, diverse, inconsequential to efficacy.

14. A decorative linking element as defined in claim 8, wherein said decorative linking element is fastened to a decorative accessory, cover, disguise, and/or enhancement and is affixed to the clip at first end A by magnetic component.

15. A decorative linking element as defined in claim 8, wherein said decorative linking element remains affixed to the clip by magnetic force until intentionally removed.

16. A decorative linking element as defined in claim 8, wherein said decorative linking element secures a decorative accessory to the wearable acupressure band.
